(19) United States
(12) Patent Application Publication
(10) Pub. No.: US 2015/0091912 A1
(43) Pub. Date: Apr. 2, 2015

(54) INDEPENDENT MEMORY HEAPS FOR SCALABLE LINK INTERFACE TECHNOLOGY

(71) Applicant: NVIDIA Corporation, Santa Clara, CA (US)

(72) Inventor: Dwayne Swoboda, San Jose, CA (US)

(73) Assignee: NVIDIA Corporation, Santa Clara, CA (US)

(21) Appl. No.: 14/040,048

(22) Filed: Sep. 27, 2013

(51) Int. Cl. G06T 1/60; G06T 1/20

(52) U.S. Cl. CPC G06T 1/60; G06T 1/20
USPC 345/505

(57) ABSTRACT

A method to render graphics on a computer system having a plurality of graphics-processing units (GPUs) includes the acts of instantiating an independent physical-memory allocator for each GPU, receiving a physical-memory allocation request from a graphics-driver process, and passing the request to one of the independent physical-memory allocators. The method also includes creating a local physical-memory descriptor to reference physical memory on the GPU associated with that physical-memory allocator, assigning a physical-memory handle to the local physical-memory descriptor, and returning the physical-memory handle to the graphics-driver process to fulfill a subsequent memory-map request from the graphics-driver process.

### BACKGROUND

A graphics processing unit (GPU) of a computer system includes numerous processor cores, each one capable of executing a different software thread. As such, a GPU is naturally applicable to parallel processing. The most typical parallel-processing application of a GPU is the rendering of high-resolution graphics, where different software threads may be tasked with rendering different portions of an image, and/or different image frames in a video sequence.

In computer systems equipped with a plurality of GPUs, an even greater degree of parallel processing may be available. The technology that enables parallel processing in multi-GPU systems is known as the ‘scalable link interface’ (SLI). SLI includes a software layer that provides driver support and memory virtualization for each GPU installed in a computer system. One objective of this invention is to enable SLI to function efficiently even when the installed GPUs differ from each other with respect to generation and/or frame-buffer size.

### BRIEF DESCRIPTION OF THE DRAWINGS

This disclosure will be better understood from reading the following detailed description with reference to the attached drawing figures, wherein:

FIGS. 1 and 2 show aspects of example computer systems having a plurality of GPUs configured as an SLI group, in accordance with embodiments of this disclosure; and

FIG. 3 illustrates an example method to render graphics on a computer system having a plurality of GPUs configured as an SLI group, in accordance with an embodiment of this disclosure.

### DETAILED DESCRIPTION

Aspects of this disclosure will now be described by example and with reference to the illustrated embodiments listed above. Components, process steps, and other elements that may be substantially the same in one or more embodiments are identified coordinately and described with minimal repetition. It will be noted, however, that elements identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see.

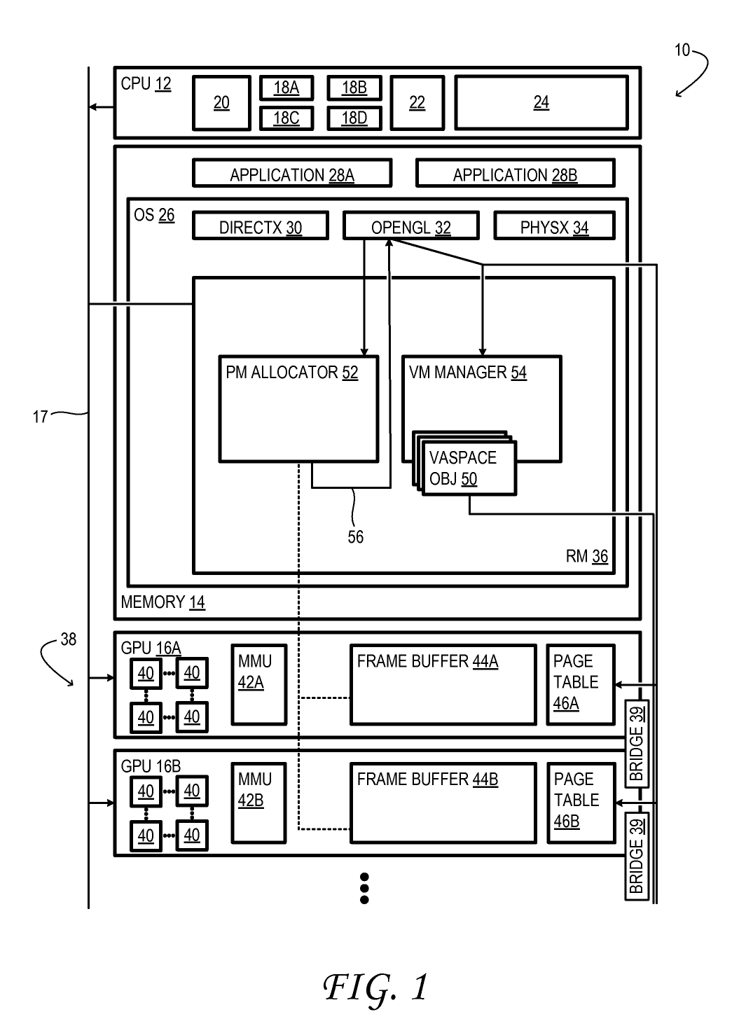

FIG. 1 shows aspects of an example computer system 10 configured for high-performance graphics rendering. In the various embodiments here contemplated, the computer system may be a desktop computer system, a laptop computer system, a workstation, or video-game system. In still other embodiments, the computer system may be a tablet computer system or smartphone, for example. Computer system 10 includes a central processing unit (CPU) 12, associated memory 14, and a plurality of GPUs 16. In one embodiment, each GPU may be operatively coupled to the CPU via system bus 17, arranged on the motherboard of the computer system. The system bus may be a PCIe bus in one, non-limiting example. In some embodiments, each GPU may occupy its own graphics card installed on the motherboard; in other embodiments, a single graphics card may include two or more GPUs.

In the illustrated embodiment, CPU 12 is a modern, multi-core CPU with four processor cores 18. Associated with the processor cores is a memory cache 20, a memory controller 22, and an input/output (IO) controller 24. In general, the memory associated with CPU 12 may include volatile and non-volatile memory. The memory may conform to a typical hierarchy of static and or dynamic random-access memory (RAM), read-only memory (ROM), magnetic, and/or optical storage. In the embodiment illustrated in FIG. 1, one portion of the memory holds an operating system (OS) 26, and another portion of the memory holds applications 28. In this and other embodiments, additional portions of the memory may hold additional components of the OS—e.g., drivers and a framework—while still other portions of the memory may hold data.

OS 26 may include a kernel and a plurality of graphics drivers—DirectX driver 30, OpenGL driver 32, and PhysX driver 34, among others. The OS also includes resource manager (RM) 36 configured inter alio to enact SLI functionality, as further described hereinafter.

In FIG. 1 the various GPUs 16 installed in computer system 10 are operatively coupled to form SLI group 38. In the illustrated embodiment, each successive pair of GPUs is linked together via an SLI bridge 39. The GPUs may be intended primarily to render graphics for processes running on the computer system, but other uses are contemplated as well. For example, the computer system may be configured as a graphics server that renders graphics on behalf of one or more remote clients and/or terminals. In still other examples, the GPUs of the SLI group may be used for massively parallel processing unrelated to graphics, per se.

Each GPU 16 includes a plurality of processor cores 40, a memory-management unit (MMU) 42 and associated RAM, such as dynamic RAM (DRAM). Naturally, each GPU may also include numerous components not shown in the drawings, such as a monitor driver. The GPU RAM includes a frame buffer 44 and a page table 46. The frame buffer is accessible to the processor cores via a memory cache system (not shown in the drawings). The frame buffer may be configured to store pixels of an image as that image is being rendered. In general, the frame buffer may differ in size from one GPU to the next within SLI group 38. The page table holds a mapping that relates the physical-address space of the GPU RAM to the virtual-memory address (VA) space of the various processes running on the computer system. In one embodiment, the MMU uses data stored in its associated page table to map the virtual memory addresses specified in process instructions to appropriate physical addresses within the frame buffer.

It will be noted that no aspect of the drawings should be interpreted in a limiting sense, for numerous other configurations lie fully within the spirit and scope of this disclosure. For instance, although each page table 46 in FIG. 1 is shown residing in the local memory of its associated GPU 16, this aspect is by no means necessary. In other embodiments, one or more page tables may reside in system memory 14. Furthermore, although this disclosure refers generally to ‘graphics drivers’ providing instructions for processing by the GPUs of the SLI group, other software constructs may also provide such instructions—additional kernel drivers or video drivers, for example. Moreover, on platforms configured for general-purpose GPU computing—e.g., CUDA®, a registered trademark of NVIDIA Corporation of Santa Clara, Calif.—the instructions may originate from one or more dedicated application-programming interfaces (APIs) or other software constructs.

As noted above, various graphics drivers and other software in computer system 10 are configured to encode instructions for processing by GPUs 16. Such instructions may include graphics-rendering and memory-management instructions, for example. A sequence of such instructions is referred to as a ‘method stream’ and may be routed to one or more GPUs via a push buffer. In one embodiment, the GPUs pull the method stream across system bus 17 to execute the instructions. RM 36 is responsible for programming host-interface hardware within each GPU so that the GPUs are able to properly pull the instructions as required by the graphics drivers. In some embodiments, the host-interface hardware implements subdevice-mask functionality that controls which GPU or GPUs an instruction is processed by. For example, the subdevice mask may specify processing by zero or more GPUs via a binary bit field—e.g., 0x1 to specify GPU A, 0x2 to specify GPU B, 0x3 to specify GPUs A and B, 0x7 to specify GPUs A, B, and C, etc. In this example, the RM programs each GPU with a unique ID at boot time so that each GPU knows which bit to look for to trigger instruction processing.

The instructions from a given process (a.k.a. channel) reference a VA space common to all GPUs but specific to that process. The virtual memory within the VA space has a heap structure, with dynamically evolving free and committed portions. In the illustrated embodiment, each process has a VA space object 50 instantiated in RM 36. The VA space object maps memory resources used by that process into the same process-specific VA space. Such resources may be referenced in the push buffer, for example, or in an output buffer, render buffer, index buffer, or vertex buffer, etc. In some embodiments, the same VA space is used for all the GPUs of SLI group 38. The physical memory resources referenced in the various VA spaces are located on the GPUs 16 of the SLI group. Like the virtual memory described above, the physical memory also has a heap structure. In the example of FIG. 1, every GPU shares, effectively, the same physical-memory heap.

As used herein, a ‘memory-map request’ is a request made by a process to map a portion of its VA space to physical memory on one or more GPUs 16. The request is fulfilled stepwise—e.g., with calls to various APIs of OS 26. Specifically, a system-wide physical-memory allocator API 52 allocates the physical memory, and a virtual-memory manager API 54 maps the allocated physical memory into the requested portion of VA space. In the embodiment illustrated in FIG. 1, the physical-memory allocator and virtual-memory manager APIs are part of RM 36.

In the embodiment of FIG. 1, the graphics driver or other requesting process passes certain parameters to physical-memory allocator 52, which may include an SLI group ID and requested size of the allocation. The physical-memory allocator is configured to locate available memory in the array of GPUs. The physical-memory allocator then reserves the requested physical memory and returns a memory descriptor 56. The memory descriptor is a data structure that includes an offset into the physical address heap where the reserved memory will be found. The requesting process then calls into the virtual-memory manager 54, which maps the physical-memory offset into the requesting process's VA space. In doing so, the virtual-memory manager may set up a virtual-address handle for the requested memory resource. Then, the VA space manager uses the virtual-address handle and the physical-memory offset to create a page-table entry relating the newly backed virtual address to the corresponding physical-memory address. With access to the appropriate page table 46, the on-board MMU 42 of each GPU can translate any valid virtual address present in the method stream to an equivalent physical-memory address.

Accordingly, the graphics driver or other requesting process can, after a successful memory-map request, reference GPU memory resources in the push buffer by an appropriate virtual address. In some scenarios, all the GPUs in an SLI group will read from the push buffer and perform the indicated operations. In other scenarios, as noted above, a subdevice mask in the method stream controls which GPU or GPUs a particular instruction is received by.

In the configuration of FIG. 1, shared physical-memory allocator 52 requires physical video memory allocations to be maintained at the same offset between all GPUs in the SLI group. Shared physical-memory allocation is one way to satisfy the more general condition to keep the GPU virtual-address spaces symmetric between all GPUs of the group. This, in turn, enables a method stream to be broadcast to all GPUs to effect parallel image or video rendering. On the other hand, the configuration of FIG. 1 presents several disadvantages in scenarios where the various GPUs differ in generation and/or frame-buffer size. One issue arises from the fact that the same physical-memory allocator is used to identify available memory on all GPUs concurrently. In effect, every GPU installed in the system is forced to share the same physical-memory heap, regardless of frame-buffer size. At best, additional memory in a larger frame buffer is unavailable to the requesting process. In other words, memory allocation is limited based on the constraints of the smallest frame buffer. In other scenarios, differences in the number of frame-buffer partitions between the installed GPUs may cause SLI to fail entirely, or greatly increase the complexity of the drivers needed to support SLI.

Another issue in the approach of FIG. 1 arises from the fact that any request for physical-memory allocation will result in memory being allocated on all GPUs concurrently, even if the requesting process requires only one GPU. Once the memory is allocated it becomes unavailable for any other process until the allocating process releases it. Furthermore, initializing GPUs with differently sized frame buffers is a complex task, due in part to the need to symmetrically address the physical-memory heap for each of the installed GPUs.

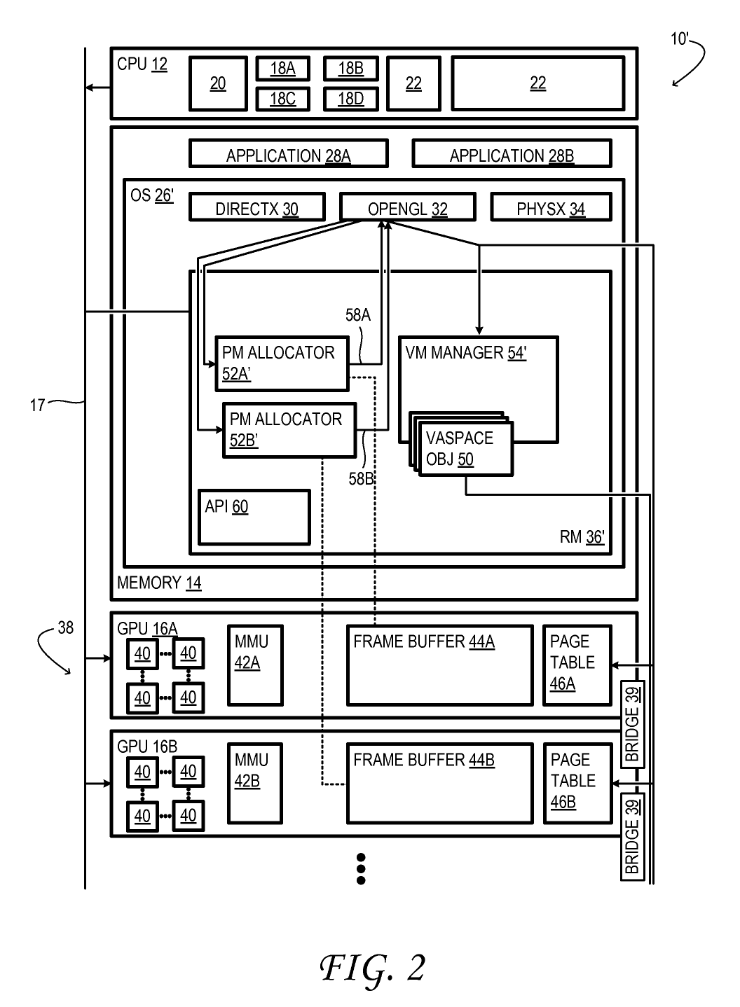

To address these issues and provide still other advantages, this disclosure embraces the computer-system configuration of FIG. 2. The embodiment of FIG. 2 maintains the symmetry of the virtual-address spaces for every GPU in the SLI group, but does not require every GPU to share the same physical-memory heap.

In the approach of FIG. 2, the system-wide physical-memory allocator API 52 is replaced by multiple physical-memory allocators 52′—one for each GPU. Effectively, this change provides multiple physical-memory heaps, which may differ in size from one GPU to the next. As in the previous embodiment, the physical-memory allocator creates a memory descriptor with an offset into the physical-memory space where the allocated memory will be found. In this embodiment, however, the memory descriptor is a local memory descriptor 58 (local to its associated GPU), and the offset it contains is GPU-specific. The local memory descriptor includes one or more fields that specify the location and size of a physical-memory allocation within the memory heap of the associated GPU. Other physical-memory attributes may be specified too, such as page size and/or compression format. Per-GPU specification of the compression format is an advantage when the SLI group includes GPUs that differ with respect to compression format.

To globally represent a physical-memory allocation across SLI group 38, local memory descriptors for each GPU of the group may be assembled subsequently into an overarching top-level memory descriptor structure. In one embodiment, the system loops through all GPUs of the SLI group, storing information contained in the local memory descriptors and incorporating such information into the top-level memory descriptor.

To reduce the impact of supporting multiple physical-memory heaps in code that allocates physical memory, the physical-memory allocator request in the embodiment of FIG. 2 returns a handle rather than a pointer to the relevant memory descriptor. If the physical-memory allocation spans multiple GPUs, the handle will reference the top-level memory descriptor. In this manner, the different underlying physical addresses are hidden under an abstracted top-level memory descriptor structure. If the physical-memory allocation is confined to a single GPU, then no top-level memory descriptor is created, and the handle will reference the local memory descriptor instead. In pseudo-code,

```
MEMORY_DESCRIPTOR *AllocMemoryInternal(gpulist, size, etc.)
{
  // if single gpu return local memdesc here
  if (singlegpu)
    return AllocMemoryForGPU(gpu)
  // multi-GPU, allocate top level memdesc
  MEMORY_DESCRIPTOR *pMemDesc = AllocMemDesc( );
  pMemDesc->type = top-level;
  foreach (gpuid in gpulist)
  {
    pMemDesc->localmemdesc[gpuid] =
    AllocMemoryForGPU(gpuid, size, etc.);
  }
  return pMemDesc;
}
```

In one example implementation, the graphics-driver process might call

```
    HANDLE AllocMemoryAPI (gpulist, size, etc.)
    {
      MEMORY_DESCRIPTOR *pMemDesc = AllocMemoryInternal
      (gpulist, size, etc.)
      return TranslateMemDescToHandle(pMemDesc); // return handle
back to process not RM internal type
    }
```

Equipped with the handle and with the ID of a particular GPU in the SLI group, RM 36′ can recover the GPU-specific physical-memory offset for any physical-memory allocation,

MapMemory(HANDLE hMemory )
{
MEMORY_DESCRIPTOR *pMemDesc =
TranslateHandleToMemDesc( hMemory );
etc.
}

As in the previous embodiment, the allocated physical memory is mapped into the VA space of the requesting process through another call into RM 36′,

VIRTMEMHANDLE hVA=MapMemory(hMemory).

In a first phase of this process, the requested VA space range is reserved. In a second, subsequent phase, the reserved VA space range is backed with the allocated physical memory. When writing out the page tables the VA space manager iterates through all the GPUs, retrieving the local memory descriptor for each one, and programs page tables 46 accordingly.

FIG. 2 also shows an additional API 60 in RM 36′, which allows clients to select which GPU or GPUs the memory-management APIs will operate on. This aspect enables a video application to allocate memory on a chosen subset of the installed GPUs.

In practice, code that formerly referenced a physical GPU memory address—e.g., a frame buffer address—is modified to reference the physical memory handle instead. Within RM 48′, a component that needs to access memory can reference either the top-level memory descriptor that contains address information for all GPUs, or a local memory descriptor that points to physical memory in only one GPU.

The configuration of FIG. 2 provides numerous advantages. First, it enables GPUs with differently sized frame buffers to be supported in an SLI configuration without wasting memory. Second, it offers client drivers better control over which GPUs from which to allocate memory. Third, it more effectively decouples the GPUs of an SLI group, making it practical to install power features to power off GPUs individually. This aspect is especially important for notebook systems that use SLI. Fourth, implementation of the embodiment of FIG. 2 will make it unnecessary to loop over all GPUs of the SLI group during initialization and rendering, which makes the driver code simpler and more robust.

The configurations described above enable various methods to render graphics on a computer system. Accordingly, some such methods are now described, by way of example, with continued reference to the above configurations. It will be understood, however, that the methods here described, and others fully within the scope of this disclosure, may be enabled by other configurations as well. Naturally, each execution of a method may change the entry conditions for a subsequent execution and thereby invoke a complex decision-making logic. Such logic is fully contemplated in this disclosure. Further, some of the process steps described and/or illustrated herein may, in some embodiments, be omitted without departing from the scope of this disclosure. Likewise, the indicated sequence of the process steps may not always be required to achieve the intended results, but is provided for ease of illustration and description. One or more of the illustrated actions, functions, or operations may be performed repeatedly, depending on the particular strategy being used.

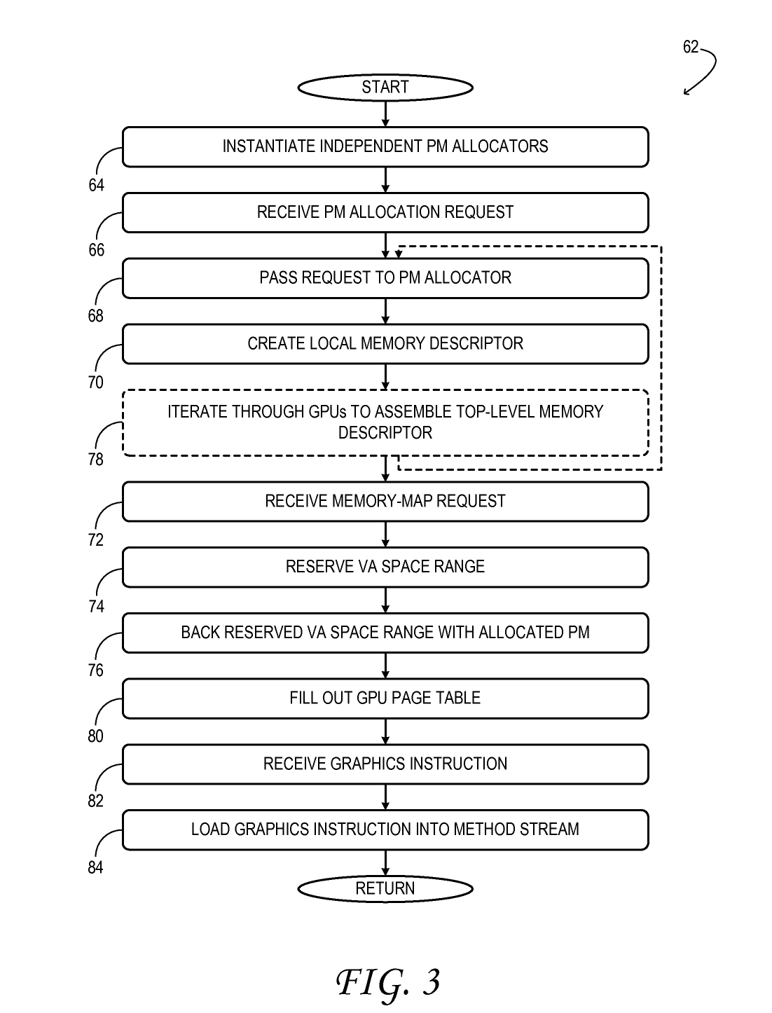

FIG. 3 illustrates an example method 62 to render graphics on a computer system having a plurality of GPUs configured as an SLI group. Such graphics may be rendered in split-frame or alternate-frame modes, for example. Method 62 is also applicable to SLI antialiasing. At 64 of method 62, an independent physical-memory allocator is instantiated for each GPU of the SLI group. In one embodiment, each independent physical-memory allocator may be instantiated in an RM module of the OS of the computer system. Likewise, an independent virtual-address space object may be instantiated by a virtual-memory manager of the OS for each graphics-driver process running on the system—or more generally, each process requiring GPU services.

At 66 a physical-memory allocation request from a graphics-driver process is received in the RM module of the OS. In one embodiment, the physical-memory allocation request may specify exactly one GPU on which to allocate physical memory. In one embodiment, the graphics-driver process may specify which GPU or GPUs on which to allocate memory via an API call to an API provided in the RM.

At 68 the physical-memory allocation request is passed to one of the independent physical-memory allocators—viz., the physical memory allocator associated with a GPU on which the memory is to be allocated. At 70 a local memory descriptor is created by that physical-memory allocator. The local memory descriptor may include a field that specifies the physical address (e.g., offset) of the allocated physical memory on the associated GPU. In some embodiments, a handle is assigned to the local memory descriptor. This handle may be returned to the graphics-driver process and used to fulfill a subsequent memory-map request from the graphics-driver process. As noted above, the local memory descriptor may also include compression information particular to the associated GPU. At optional step 78, the system iterates through all GPUs of the SLI group to assemble a top-level memory descriptor from data contained in the various local memory descriptors. In this scenario, the handle returned to the graphics-driver process may be a handle to the top-level memory descriptor instead of the local memory descriptor referred to above. In scenarios in which the physical memory allocation is limited to one GPU, however, the handle returned to the graphics-driver process may reference only the local memory descriptor, as indicated above.

At 72 of method 62, a memory-map request is received from the graphics-driver process. Pursuant to the memory-map request, a VA space range specified in the memory-map request is reserved at 74. At 76 the reserved VA space range is backed with the physical memory allocated previously in method 62. At 80 a page table of the associated GPU is filled out to reflect the backing of the reserved VA space range with the allocated physical memory. In one embodiment, the page tables may be filled out by a VA space manager instantiated in the OS from which the graphics-driver process was launched. Then the physical-memory offset is extracted from the local memory descriptor, and a page-table entry is written based on the physical-memory offset and the virtual-memory handle.

At 82 of method 62, a graphics instruction is received from the graphics-driver process into the RM. The graphics instruction may include a clear instruction, a render instruction, or a copy instruction, as examples. Typically, the graphics instruction may reference the VA space of the graphics driver that issued the instruction. At 84 the graphics instruction is loaded by the RM into a method stream accessible to the GPUs of the SLI group. As noted above, the method stream may include a subdevice mask that causes the instruction to be processed by a select one or more GPUs and ignored by the others.

It will be understood that the configurations and/or approaches described herein are exemplary in nature, and not to be considered in a limiting sense, because numerous variations are possible. The specific routines or methods described herein may represent one or more of any number of processing strategies. As such, various acts illustrated and/or described may be performed in the sequence illustrated, in other sequences, in parallel, or omitted.

The subject matter of this disclosure includes all novel and non-obvious combinations and sub-combinations of the various systems and configurations, process, functions, acts, and/or properties disclosed herein, as well as any and all equivalents thereof.

1. A method to render graphics on a computer system having a plurality of graphics-processing units (GPUs), the method comprising:
instantiating an independent physical-memory allocator for each GPU;
receiving a physical-memory allocation request from a graphics-driver process;
passing the physical-memory allocation request to one of the independent physical-memory allocators;
creating a local physical memory descriptor to reference physical memory allocated on the GPU associated with said one of the independent physical memory allocators;
assigning a physical-memory handle to the local physical-memory descriptor; and
returning the physical-memory handle to the graphics-driver process to fulfill a subsequent memory-map request from the graphics-driver process.

2. The method of claim 1 wherein each independent physical-memory allocator is instantiated in a resource manager component of the operating system of the computer system.

3. The method of claim 1 wherein the physical-memory allocation request specifies exactly one GPU on which to allocate physical memory.

4. The method of claim 1 wherein the physical-memory allocation request is received in a resource manager component of the operating system of the computer system.

5. The method of claim 1 wherein the graphics-driver process is one or more of a DirectX driver process, an OpenGL driver process, and a PhysX driver process.

6. The method of claim 1 further comprising receiving a subsequent memory-map request from the graphics-driver process.

7. The method of claim 6 further comprising reserving a virtual-memory address (VA) space range specified in the memory-map request.

8. The method of claim 7 further comprising backing the reserved VA space range with the physical memory allocated on the associated GPU.

9. The method of claim 8 further comprising filling out a page table of the associated GPU to reflect the backing of the reserved VA space range with the allocated physical memory.

10. The method of claim 9 wherein the page tables are filled out by a virtual-address space manager instantiated in the operating system of the computer system, and wherein the graphics-driver process is launched from the operating system.

11. The method of claim 9 wherein filling out the page tables includes:
accessing the local memory descriptor for each GPU specified in the physical memory allocation request;
extracting a physical-memory offset from the local memory descriptor; and
writing a page-table entry including the physical-memory offset and a virtual-memory handle.

12. The method of claim 1 wherein the physical memory handle is assigned to the local physical-memory descriptor when the physical-memory allocation request specifies exactly one GPU on which to allocate physical memory, the method further comprising:
when the physical-memory allocation request specifies two or more GPUs on which to allocate physical memory, iterating over each of the two or more GPUs to assemble a top-level physical-memory descriptor and assign the physical-memory handle to the top-level physical-memory descriptor.

13. The method of claim 1 further comprising receiving a graphics instruction from the graphics-driver process, the graphics instruction referencing a virtual-memory address space of the graphics-driver process.

14. The method of claim 13 further comprising loading the graphics instruction into a method stream accessible to the associated GPU.

15. The method of claim 14 wherein the method stream includes a subdevice mask that causes the instruction to be processed by only the associated GPU.

16. The method of claim 1 wherein the local memory descriptor includes compression information particular to the associated GPU.

17. A computer system comprising:
a plurality of graphics processing units (GPUs); and
memory operatively coupled to a central processing unit, the memory holding instructions that cause the central processing unit to:
instantiate an independent physical-memory allocator for each GPU;
receive a physical-memory allocation request from a graphics-driver process;
pass the physical-memory allocation request to one of the independent physical-memory allocators;
create a local memory descriptor to reference physical memory on the GPU associated with said one of the independent physical-memory allocators;
when the physical-memory allocation request specifies exactly one GPU on which to allocate physical memory, assign a physical-memory handle to the local physical memory descriptor;
when the physical-memory allocation request specifies two or more GPUs on which to allocate physical memory, iterate over each of the two or more GPUs to assemble a top-level memory descriptor and assign the physical-memory handle to the top-level physical-memory descriptor; and
return the physical-memory handle to the graphics-driver process to fulfill a subsequent memory-map request from the graphics-driver process.

18. The computer system of claim 17 further comprising a scalable link-interface bridge connecting each pair of GPUs.

19. A method to render graphics on a computer system having a plurality of graphics-processing units (GPUs), the method comprising:
instantiating, in an operating system of the computer system, an independent physical-memory allocator for each GPU;
receiving a physical-memory allocation request from a graphics-driver process;
passing the physical-memory allocation request to one of the independent physical-memory allocators;
creating a physical-memory handle to a local memory descriptor to reference physical memory on the GPU associated with said one of the independent physical-memory allocators;
returning the physical-memory handle to the graphics-driver process;
receiving a subsequent memory-map request from the graphics-driver process;
reserving a virtual-memory address (VA) space range specified in the memory-map request;
backing the reserved VA space range with the physical memory allocated on the associated GPU;
filling out a page table of the associated GPU to reflect the backing of the reserved VA space range with the physical memory allocated on the associated GPU;
receiving a graphics instruction referencing the VA space range; and
loading the graphics instruction into a method stream accessible to the associated GPU.

20. The method of claim 18 wherein the graphics-driver process is one of a plurality of graphics-driver processes running on the computer system, the method further comprising instantiating in the OS an independent virtual-address space object for each of the graphics-driver processes.
